(19) United States
(12) Patent Application Publication
(10) Pub. No.: US 2018/0194001 A1
(43) Pub. Date: Jul. 12, 2018

(54) WORK ARM FOR A POWER WORK DEVICE

(71) Applicant: Tech Rim Standards, LLC, Rochester Hills, MI (US)

(72) Inventors: TODD M. CLEES, Grand Blanc, MI (US); Marek P. Bieciuk, Shelby Twp, MI (US)

(21) Appl. No.: 15/400,182

(22) Filed: Jan. 6, 2017

(51) Int. Cl. B25J 9/04; B25J 19/00

(52) U.S. Cl. CPC B25J 9/04; B25J 19/0091

(57) ABSTRACT

A number of variations may include a work arm comprising: a first side plate; a second side plate; a base plate, wherein the first side plate and the second side plate are attached to a back surface of the base plate, wherein the base plate includes at least one opening defined by an inner surface of the base plate; a bottom plate attached to a first side face of the first side plate and a second side face of the second side plate; and a pivot component, wherein the pivot component extends perpendicularly from the bottom plate and includes a through-hole defined by an inner surface of the pivot component.

### TECHNICAL FIELD

The field to which the disclosure generally relates to includes power work devices.

### BACKGROUND

A power work device may include a work arm.

### SUMMARY OF ILLUSTRATIVE VARIATIONS

A number of variations may include a work arm comprising: a first side plate; a second side plate; a base plate, wherein the first side plate and the second side plate are attached to a back surface of the base plate, wherein the base plate includes at least one opening defined by an inner surface of the base plate; a bottom plate attached to a first side face of the first side plate and a second side face of the second side plate; and a pivot component, wherein the pivot component extends perpendicularly from the bottom plate and includes a through-hole defined by an inner surface of the pivot component.

A number of variations may include a product comprising: a base plate having a top face, a bottom face, a front face, a rear face, a first side face, and a second side face, a plurality of mounting holes which extend through the top face and the bottom face adjacent the front face and the rear face; a first side plate attached to the bottom face of the base plate adjacent the first side face and a second side plate attached to the bottom face of the base plate adjacent the second side face, wherein the first side plate includes a first through hole and the second side plate includes a second through hole; and a bottom plate having a top face, a bottom face, a front face, a rear face, a first side face, and a second side face, wherein the bottom face includes a pivot component which extends perpendicularly from the bottom face and includes a through hole.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a perspective view of a power work device according to a number of variations.

FIG. 2 illustrates a close-up perspective view of a work arm of a power work device according to a number of variations.

FIG. 3 illustrates a close-up perspective view of a work arm of a power work device according to a number of variations.

FIG. 4 illustrates a close-up side view of a work arm of a power work device according to a number of variations.

FIG. 5 illustrates a close-up rear view of a work arm of a power work device according to a number of variations.

### DETAILED DESCRIPTION OF ILLUSTRATIVE VARIATIONS

The following description of the variations is merely illustrative in nature and is in no way intended to limit the scope of the invention, its application, or uses.

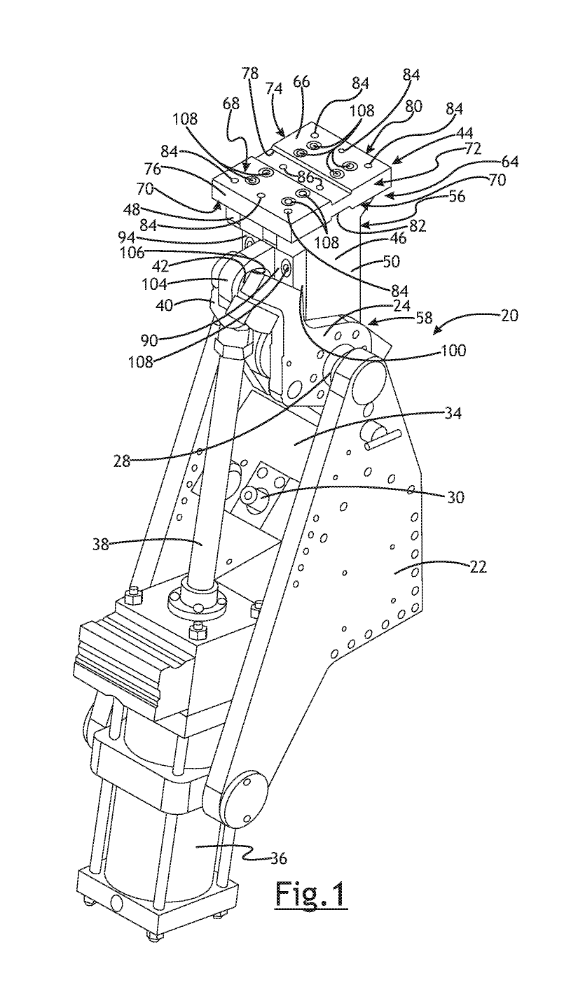

Referring to FIG. 1, in a number of variations, a power work device 20 may be used in any number of assembly processes to control the position and movement of any number of components including, but not limited to, tools and products. In a number of variations, the power work device 20 may include a work arm 44 which may be constructed and arranged to accommodate the one or more components. The power work device 20 may be constructed and arranged so that the work arm 44 may be moved between a first position and a second position with the use of an actuator 36 to move the one or more components between a first position and a second position.

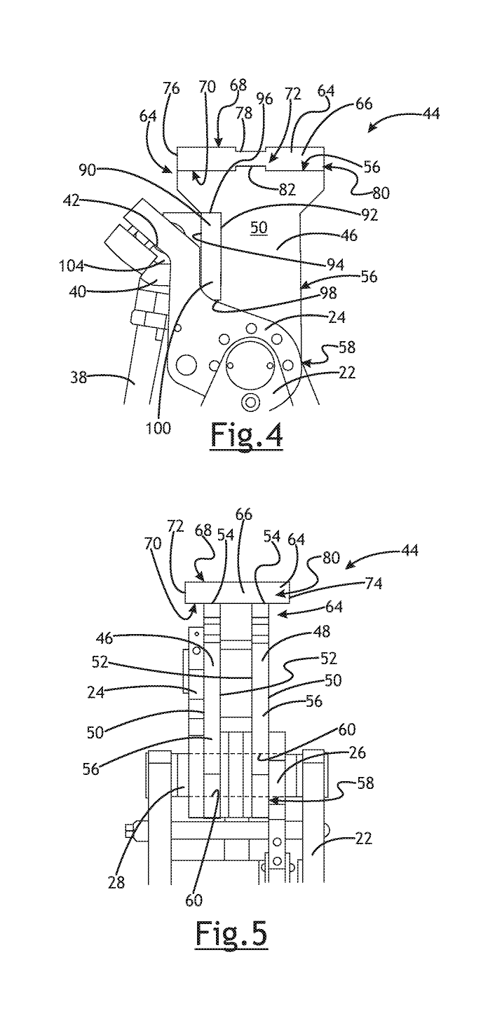

Referring to FIGS. 1-5, in a number of variations, a work arm 44 may include a first side plate 46, a second side plate 48, a base plate 66, and a bottom plate 90. In a number of variations, the first side plate 46 and the second side plate 48 may be planar and may each include a top face 50 and an opposite bottom face 52, a front face 54, and a side face 56. The first end 58 of the first and second side plates 46, 48 may be rounded and the second ends 64 may be flared outward from the first end 58 so that the width of the first end 58 may be less than the width of the second end 64, a variation of which is illustrated in FIG. 4. The first end 58 may include a through-hole 60 defined by an inner surface of the side plate 46, 48, a variation of which is illustrated in FIG. 5, constructed and arranged to accommodate a shaft 28 of a power work device 20, as will be discussed hereafter.

In a number of variations, the base plate 66 may be rectangular and may include a top face 68, a bottom face 70, a first side face 72, a second side face 74, a front face 76, and a rear face 80. The top face 68 may include a cutout 78 which may act as a keyway for attachment of one or more components to assist in positioning and locating of the one or more components onto the work arm 44. The bottom face 70 may also include a cutout 82 which may be symmetrically opposite of the cutout 78 in the top face 68 which may allow for the top face 68 or the bottom face 70 of the base plate 66 to be used as the mounting surface for the one or more components. The base plate 66 may include any number of mounting holes 84 defined by an inner surface of the base plate 66, which may be constructed and arranged to accommodate one or more mechanical fasteners which may be used to attach a component including, but not limited to, a tool or product, onto the work arm 44. In a number of variations, the mounting holes 84 may be arranged through the top face 68 and the bottom face 70 adjacent the front face 76 and the rear face 80 of the base plate 66. In a number of variations, the mounting holes 84 may be threaded to accommodate one or more threaded mechanical fasteners. In a number of variations, the base plate 66 may also include one or more through-holes 86 defined by an inner surface of the base plate 66 which may extend through the cutouts 78, 82 in the base plate 66 and which may be constructed and arranged to accommodate one or more dowels which may be used to assist in locating and positioning components which may be attached to the work arm 44. The base plate 66 may also include a plurality of through holes 88 defined by an inner surface of the base plate 66 which may be constructed and arranged to accommodate one or more mechanical fasteners 108 which may be used to attached the base plate 66 to the first side plate 46 and the second side plate 48, as will be discuss hereafter.

In a number of variations, the second end 64 of each of the first side plate 46 and the second side plate 48 may be attached to the bottom face 70 of the base plate 66. The first side plate 46 and the second side plate 48 may be attached to the base plate 66 in any number of variations including, but not limited to, one or more mechanical fasteners 108 (a variation of which is illustrated in FIG. 1) and/or welding.

In a number of variations, a bottom plate 90 may include a top face 92, a bottom face 94, a front face 96, a rear face 98, a first side face 100, and a second side face 102 (best illustrated in FIGS. 3 and 4). In a number of variations, the bottom face 94 may include a pivot component 104 which may extend perpendicularly from the bottom face 94 and may be centrally located on the bottom face 94 of the bottom plate 90. The pivot component 104 may include a through-hole 106 defined by an inner surface of the pivot component 104 which may be constructed and arranged to accommodate a shaft 42 of the power work device 20 so that the pivot component 104 may pivot about the shaft 42, as will be discussed hereafter. In a number of variations, the bottom plate 90 may be attached to the side face 56 of the first and second side plates 46, 48 so that the top face 68 of the bottom plate 90 may be attached to a side face 56 of the first side plate 46 and the second side plate 74. The bottom plate 90 may be attached to the first and second side plates 46, 48 in any number of variations including, but not limited to, one or more mechanical fasteners 108 (a variation of which is illustrated in FIG. 1) and/or welding.

The work arm 44 may comprise any number of metallic materials including, but not limited, 4140 alloy steel.

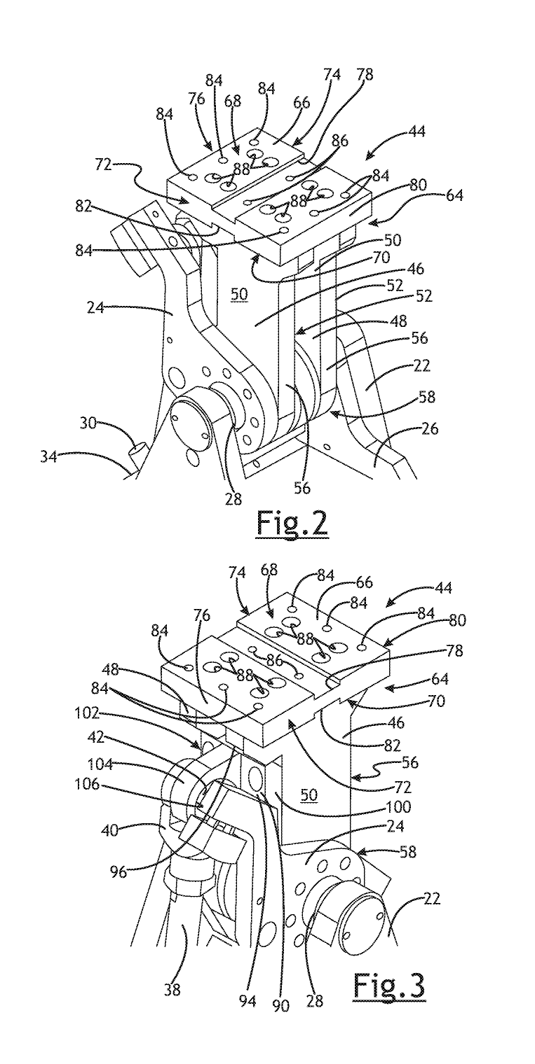

Referring again to FIG. 1, in a number of variations, the work arm 44 may be attached to any number of power work devices 20 including, but not limited to, a power work device 20 as disclosed in patent application Ser. No. 14/146,939 which is hereinafter incorporated by reference. A power work device 20 may include a housing 22, a first stop arm 24, a second stop arm 26 (variations of which are illustrated in FIGS. 2 and 5) operatively attached to a first shaft 28 (best illustrated in FIG. 5) which may rotate with the first shaft 28. A first shock absorber 30 and a second shock absorber (not illustrated) may be attached to a stop plate 34 so that the first shock absorber 30 may be aligned with the first stop arm 24 and so that the second shock absorbed may be aligned with the second stop arm 26. In a number of variations, the power work device 20 may include an actuator 36 which may include an actuator shaft 38 which may be driven linearly between a fore and aft position by the actuator 36. The actuator shaft 36 may include a pivot end 40 which may support a second shaft 42.

In a number of variations, the work arm 44 may be attached to the first shaft 28 and the second shaft 42 of the power work device 20. The first shaft 28 of the power work device 20 may extend through the first ends 58 of the first side plate 46 and the second side plate 48 so that the work arm 44 may pivot about the first shaft 28 of the power work device 20. In a number of variations, the second shaft 42 of the power work device 20 may extend through the through-hole 106 in the pivot component 104 of the bottom plate 90 of the work arm 44 so that the work arm 44 may also pivot about the second shaft 42 of the power work device 20. The actuator 36 may cause the actuator shaft 38 to move linearly between a first position and a second position which may cause the work arm 44 to rotate between a first position and a second position.

The above construction of the work arm 44 using a first and second side plate 46, 48, a base plate 66, and a bottom plate 90 may increase the strength of the work arm 44 which may allow the work arm 44 to support a substantial amount of weight, as compared to a work arm having a single plate. This may allow for the work arm 44 to move large components including, but not limited to, vehicle bodies. Further, the use of two side plates 46, 48 may reduce and/or eliminate deflecting of the work arm 44 during operation as compared to a work arm using a single plate. Even further, the use of a base plate 66 having mounting holes 84, dowel holes 86, and one or more keyways 78, 82 may allow for positioning and attachment of complicated tooling or components which may allow for expanded use of the work arm 44 on a wide range of applications.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a work arm comprising: a first side plate; a second side plate; a base plate, wherein the first side plate and the second side plate are attached to a back surface of the base plate, wherein the base plate includes at least one opening defined by an inner surface of the base plate; a bottom plate attached to a first side face of the first side plate and a second side face of the second side plate; and a pivot component, wherein the pivot component extends perpendicularly from the bottom plate and includes a through-hole defined by an inner surface of the pivot component.

Variation 2 may include a work arm as set forth in Variation 1 wherein the base plate further includes at least one keyway.

Variation 3 may include a work arm as set forth in any of Variations 1-2 wherein the first side plate and the second side plate are attached to the base plate via at least one first mechanical fastener.

Variation 4 may include a work arm as set forth in any of Variations 1-3 wherein the bottom plate is attached to the first side plate and the second side plate via at least one second mechanical fastener.

Variation 5 may include a work arm as set forth in any of Variations 1-4 wherein the work arm comprises a metallic material.

Variation 6 may include a work arm as set forth in any of Variations 1-5 wherein the work arm is attached to a power work device.

Variation 7 may include a work arm as set forth in Variation 6 wherein the first side plate and the second side plate are each attached to a first shaft of the power work device and the pivot component is attached to a second shaft of the power work device.

Variation 8 may include a work arm as set forth in Variation 7 wherein the first shaft is attached to a housing of the power work device and the second shaft is operatively attached to an actuator shaft of an actuator and is driven by the actuator to rotate the work arm between a first position and a second position.

Variation 9 may include a product comprising: a base plate having a top face, a bottom face, a front face, a rear face, a first side face, and a second side face, a plurality of mounting holes which extend through the top face and the bottom face adjacent the front face and the rear face; a first side plate attached to the bottom face of the base plate adjacent the first side face and a second side plate attached to the bottom face of the base plate adjacent the second side face, wherein the first side plate includes a first through hole and the second side plate includes a second through hole; and a bottom plate having a top face, a bottom face, a front face, a rear face, a first side face, and a second side face, wherein the bottom face of the bottom plate includes a pivot component which extends perpendicularly from the bottom face and includes a through hole.

Variation 10 may include a product as set forth in Variation 9 wherein the base plate further comprises a cutout which extends across at least one of the front face or the rear face of the base plate and which extends horizontally from the first side face to the second side face.

Variation 11 may include a product as set forth in Variation 10 wherein the base plate further includes at least one location hole which extends though the top face and the bottom face of the base plate within the cutout.

Variation 12 may include a product as set forth in any of Variations 9-11 wherein the work arm comprises a metallic material.

Variation 13 may include a product as set forth in any of Variations 9-12 further comprising a power work device, wherein the power work device comprises a housing, a first shaft which extends through the housing, a first stop arm and a second stop arm attached to the first shaft, an actuator having an actuator shaft, a second shaft operatively attached to the actuator shaft; wherein the first shaft extends through the first through hole in the first side plate and the second through hole in the second side plate; and wherein the second shaft extends through the pivot component of the bottom plate.

Variation 14 may include a product as set forth in Variation 13 wherein the actuator is constructed and arranged to move the actuator shaft linearly so that the work arm rotates between a first position and a second position.

The above description of select variations within the scope of the invention is merely illustrative in nature and, thus, variations or variants thereof are not to be regarded as a departure from the spirit and scope of the invention.

What is claimed is:

1. A work arm comprising:
a first side plate;
a second side plate;
a base plate, wherein the first side plate and the second side plate are attached to a back surface of the base plate, wherein the base plate includes at least one opening defined by an inner surface of the base plate;
a bottom plate attached to a first side face of the first side plate and a second side face of the second side plate; and
a pivot component, wherein the pivot component extends perpendicularly from the bottom plate and includes a through-hole defined by an inner surface of the pivot component.

2. The work arm of claim 1 wherein the base plate further includes at least one keyway.

3. The work arm of claim 1 wherein the first side plate and the second side plate are attached to the base plate via at least one first mechanical fastener.

4. The work arm of claim 1 wherein the bottom plate is attached to the first side plate and the second side plate via at least one second mechanical fastener.

5. The work arm of claim 1 wherein the work arm comprises a metallic material.

6. The work arm of claim 1 wherein the work arm is attached to a power work device.

7. The work arm of claim 6 wherein the first side plate and the second side plate are each attached to a first shaft of the power work device and the pivot component is attached to a second shaft of the power work device.

8. The work arm of claim 7 wherein the first shaft is attached to a housing of the power work device and the second shaft is operatively attached to an actuator shaft of an actuator and is driven by the actuator to rotate the work arm between a first position and a second position.

9. A product comprising:
a base plate having a top face, a bottom face, a front face, a rear face, a first side face, and a second side face, a plurality of mounting holes which extend through the top face and the bottom face adjacent the front face and the rear face;
a first side plate attached to the bottom face of the base plate adjacent the first side face and a second side plate attached to the bottom face of the base plate adjacent the second side face, wherein the first side plate includes a first through hole and the second side plate includes a second through hole; and
a bottom plate having a top face, a bottom face, a front face, a rear face, a first side face, and a second side face, wherein the bottom face of the bottom plate includes a pivot component which extends perpendicularly from the bottom face and includes a through hole.

10. The product of claim 9 wherein the base plate further comprises a cutout which extends across at least one of the front face or the rear face of the base plate and which extends horizontally from the first side face to the second side face.

11. The product of claim 10 wherein the base plate further includes at least one location hole which extends though the top face and the bottom face of the base plate within the cutout.

12. The product of claim 9 wherein the work arm comprises a metallic material.

13. The product of claim 9 further comprising a power work device, wherein the power work device comprises a housing, a first shaft which extends through the housing, a first stop arm and a second stop arm attached to the first shaft, an actuator having an actuator shaft, a second shaft operatively attached to the actuator shaft; wherein the first shaft extends through the first through hole in the first side plate and the second through hole in the second side plate; and wherein the second shaft extends through the pivot component of the bottom plate.

14. The product of claim 13 wherein the actuator is constructed and arranged to move the actuator shaft linearly so that the work arm rotates between a first position and a second position.
